(19) United States
(12) Patent Application Publication
(10) Pub. No.: US 2016/0168299 A1
(43) Pub. Date: Jun. 16, 2016

(54) HALOGENATED LATEX POLYMER AND METHOD OF MAKING SAME

(71) Applicant: ROHM AND HAAS COMPANY, Philadelphia, PA (US)

(72) Inventor: Veera Nelliappan, North Wales, PA (US)

(21) Appl. No.: 14/906,844

(22) PCT Filed: Jul. 28, 2014
(86) PCT No.: PCT/US2014/048351

§ 371 Date: Jan. 21, 2016

Related U.S. Application Data
(60) Provisional application No. 61/859,953, filed on Jul. 30, 2013.

(51) Int. Cl. C08F 265/06; C08L 51/00

(52) U.S. Cl. CPC C08F 265/06; C08L 51/003; C08L 2207/53

(57) ABSTRACT

A halogenated latex polymer, comprising from 0 to 90 percent by weight units derived from a first monomer and from 10 to 100 percent by weight units derived from a second monomer having at least one allylic group, wherein 10 to 100 percent of residual allyl groups of the second monomer are halogenated in a latex phase by dilute is provided. Also provided are: (a) a method of making the halogenated latex polymer, (b) a composition comprising the halogenated latex polymer; and (c) a method of making the composition.

### FIELD OF INVENTION

The instant invention relates to a halogenated latex polymer and method of making the same, and a composition comprising the halogenated latex polymer and method of making the same.

### BACKGROUND OF THE INVENTION

Environmental and health issues are associated with typical flame retardants, such as decabrominated diphenyl ether (decabrom); further issues with brominated flame retardants is the need for antimony trioxide synergists; also these have a tendency to form dioxins on incineration and hence pose issues. Meanwhile, polymers are ever more used in applications to save weight, especially in areas such as automotive and aerospace. These stringent applications require high performance as well as flame retardance.

One of the drawbacks of acrylic polymers is their poor flame retardancy. An approach where the polymer itself is brominated would result in the bromine not being able to leach out; however if the bromination results alkyl bromides, the bromine tends to get released at below the compounding temperatures, thus limiting its usefulness. Consequently, a polymeric flame retardant that is thermally stable to withstand high processing temperatures, (but which would still function as a flame retardant polymer) would be useful.

### SUMMARY OF THE INVENTION

The instant invention is a halogenated latex polymer and method of making the same, and a composition comprising the halogenated latex polymer and method of making the same.

In one embodiment, the instant invention provides a halogenated latex polymer, comprising from 0 to 90 percent by weight units derived from a first monomer and from 100 to 10 percent by weight units derived from a second monomer having an at least one allylic group, wherein 10 to 100 percent of the allyl groups of the second (meth)acrylate monomer are halogenated in a latex phase by halogen water.

### BRIEF DESCRIPTION OF THE DRAWINGS

For the purpose of illustrating the invention, there is shown in the drawings a form that is exemplary; it being understood, however, that this invention is not limited to the precise arrangements and instrumentalities shown.

FIG. 1: shows the Raman spectra of the brominated (lower trace) polymer in accordance with one embodiment of the invention and a comparative non-halogenated polymer control (upper trace);

FIG. 2 is a close up view of the Raman spectra of FIG. 1 focusing on the C═C and C═O bonds; and

FIG. 3 is a graph illustrating thermogravimetric analysis (TGA) traces for a non-halogenated comparative latex (solid dots) and a brominated latex in accordance with one embodiment of the invention (open squares).

### DETAILED DESCRIPTION OF THE INVENTION

The instant invention is a halogenated latex polymer and method of making the same, and a composition comprising the halogenated latex polymer and method of making the same.

The inventor has found that halogenation, and particularly bromination, of allylic unsaturation results in bromides that do not have a low decomposition temperature, and are stable up to 260° C. as well as a method of facilely brominating unreacted, or residual, allyl unsaturation in a latex polymer.

The halogenated latex polymer according to the present invention comprises: from 0 to 90 percent by weight units derived from a first monomer and from 10 to 100 percent by weight units derived from a second monomer having at least one allylic group, wherein 10 to 100 percent of residual allyl groups of the second monomer are halogenated in a latex phase by halogen water.

In an alternative embodiment, the instant invention further provides composition comprising: a blended product of: a matrix polymer; and from 0.05 to 10 wt % halogenated latex polymer, the halogenated latex polymer comprising from 0 to 90 percent by weight units derived from a first alkyl (meth)acrylate monomer and from 10 to 100 percent by weight units derived from a second (meth)acrylate monomer having an allylic group, wherein the from 10 to 100 percent of the allyl groups of the second (meth)acrylate monomer are halogenated.

In another alternative embodiment, the instant invention further provides a method of producing a halogenated latex polymer comprising: copolymerizing a first monomer copolymerized with a second to form a copolymer, wherein the second (meth)acrylate has an allyl group; and contacting the copolymer with one or more halogen-containing compounds to produce a halogenated copolymer.

All individual values and subranges from 0 to 90 percent by weight units derived from a first alkyl (meth)acrylate monomer are included herein and disclosed herein; for example, the units derived from a first alkyl (meth)acrylate monomer may range from a lower limit of 0, 10, 10, 30, 40, 50, 60, 70, 80 or 85 percent by weight to an upper limit of 5, 15, 25, 35, 45, 55, 65, 75, 85 or 90 percent by weight. For example, the amount of units derived from a first monomer may be from 0 to 90 percent by weight; or in the alternative, the amount of units derived from a first monomer may be from 30 to 70 percent by weight; or in the alternative, the amount of units derived from a first monomer may be from 50 to 90 percent by weight; or in the alternative, the amount of units derived from a first monomer may be from 40 to 60 percent by weight. The second monomer does not necessarily have to be an allyl methacrylate monomer, other monomers such as diallyl itaconate are not methacrylate monomers (as I read subsequent paragraps it looks like you have made change; point may be moot).

All individual values and subranges from 10 to 100 percent by weight units derived from a second monomer are included herein and disclosed herein; for example, the units derived from a second monomer may range from a lower limit of 10, 20, 30, 40, 50, 60, 70, 80, 90 or 95 percent by weight to an upper limit of 15, 25, 35, 45, 55, 65, 75, 85, 95 or 100 percent by weight. For example, the amount of units derived from a second monomer may be from 10 to 100 percent by weight; or in the alternative, the amount of units derived from a second monomer may be from 10 to 70 percent by weight; or in the alternative, the amount of units derived from a second monomer may be from 30 to 50 percent by weight; or in the alternative, the amount of units derived from a second monomer may be from 40 to 60 percent by weight.

All individual values and subranges from 10 to 100 percent of the allyl groups of the second (meth)acrylate monomer being halogenated are included herein and disclosed herein; for example, the percent of allyl groups halogenated may be from a lower limit of 10, 20, 30, 40, 50, 60, 70, 80 or 95 percent and from an upper limit of 15, 25, 35, 45, 55, 65, 75, 85, 95 or 100 percent. For example, the percent of allyl groups halogenated may range from 10 to 100 percent, or in the alternative, the percent of allyl groups halogenated may range from 50 to 100 percent, or in the alternative, the percent of allyl groups halogenated may range from 10 to 60 percent, or in the alternative, the percent of allyl groups halogenated may range from 45 to 85 percent.

In one embodiment, the first monomer is an alkyl (meth)acrylate. As used herein, the term “(meth)acrylate” refers to acrylate and/or methacrylate. Any alkyl (meth)acrylate may be used as the first monomer. As used herein, the term “alkyl (meth)acrylate” means a (meth)acrylate having a straight or branched chain alkyl group of 2 to 18 carbon atoms, which is exclusive of any alkyl (meth)acrylate having an aromatic ring or rings in its structure. All individual values and subranges from 2 to 18 carbon atoms are included herein and disclosed herein; for example, the number of carbon atoms may range from a lower limit of 2, 3, 4, 5, 6,7, 8, 9, 10, 11, 12, 13, 14, 15 16, or 17 to an upper limit of 3, 4, 5, 6,7, 8, 9, 10, 11, 12, 13, 14, 15 16, 17, or 18. Examples of alkyl (meth)acrylate include ethyl (meth)acrylate, n-butyl (meth)acrylate, sec-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, isomyristyl (meth)acrylate, n-tridecyl (meth)acrylate, n-tetradecyl (meth)acrylate, stearyl (meth)acrylate, and isostearyl (meth)acrylate.

The second monomer may be any monomer having at least one allylic group. Examples of (meth)acrylic monomers having an allyl group include allyl methacrylate, diallyl maleate, allyl acrylate, diallyl fumarate, diallyl itaconate, and combinations thereof.

The composition comprises from 0.05 to 10 percent by weight (wt %) halogenated latex polymer, the halogenated latex polymer comprising from 0 to 90 percent by weight units derived from a first monomer and from 10 to 100 percent by weight units derived from a second monomer having an allylic group, wherein the from 10 to 100 percent of the allyl groups of the second (meth)acrylate monomer are halogenated. All individual values and subranges from 0.05 to 10% by weight are included herein and disclosed herein; for example the amount of halogenated latex polymer may range from a lower limit of 0.05, 0.5, 2.5, 5, 7.5 or 9.5 wt % to an upper limit of 0.1, 0.7, 1.5, 3, 6, 8 or 10 wt %.

In another embodiment, the instant invention further provides a method of forming a composition comprising: blending a halogenated latex polymer in accordance with any of the embodiments described herein into a matrix polymer

In an alternative embodiment, the instant invention provides halogenated latex polymer, a method of producing a halogenated latex polymer, a composition comprising a halogenated latex polymer and a method of making the composition, in accordance with any of the preceding embodiments, except that the halogenated water is bromine water which comprises up to 3 wt % bromine/volume water (w/v). All individual values and subranges from up to 3% w/v are included herein and disclosed herein; for example, the amount of bromine in the bromine water can be from an upper limit of 1% w/v, or in the alternative, from an upper limit of 2% w/v, or in the alternative, from an upper limit of 3% w/v.

In an alternative embodiment, the instant invention provides halogenated latex polymer, a method of producing a halogenated latex polymer, a composition comprising a halogenated latex polymer and a method of making the composition, in accordance with any of the preceding embodiments, except that the second monomer is allyl methacrylate.

In an alternative embodiment, the instant invention provides halogenated latex polymer, a method of producing a halogenated latex polymer, a composition comprising a halogenated latex polymer and a method of making the composition, in accordance with any of the preceding embodiments, except that the residual allyl groups are brominated.

In an alternative embodiment, the instant invention provides halogenated latex polymer, a method of producing a halogenated latex polymer, a composition comprising a halogenated latex polymer and a method of making the composition, in accordance with any of the preceding embodiments, except that the first monomer is selected from the group consisting of butyl acrylate butyl acrylate, ethyl acrylate, 2-ethyl hexyl acrylate, propyl acrylate, methyl acrylate, hexyl acrylate, butyl methacrylate, methyl methacrylate, ethylhexyl methacrylate, benzyl acrylate, lauryl methacrylate stearyl methacrylate, styrene, substituted styrenes, acrylonitrile, and combinations of two or more thereof.

In an alternative embodiment, the instant invention provides halogenated latex polymer, a method of producing a halogenated latex polymer, a composition comprising a halogenated latex polymer and a method of making the composition, in accordance with any of the preceding embodiments, except that the halogenated latex polymer comprises polymer particles which are characterized by an average diameter from 50 nm to 50 micrometers (μm). All individual values and subranges from 50 nm to 50 μm are included herein and disclosed herein; for example, the average diameter of the polymer particles may be from a lower limit of 50 nm, 100 nm, 500 nm, 1,000 nm, 5,000 nm, 10,000 nm, 45,000 nm, to an upper limit of 60 nm, 100 nm, 500 nm, 1,000 nm, 5,000 nm, 10,000 nm, 50,000 nm. For example, the average diameter may range from 50 nm to 50 μm, or in the alternative, from 5,000 nm to 50,000 nm, or in the alternative, from 50 nm to 5,000 nm, or in the alternative, from 5,000 nm to 20,000 nm.

In an alternative embodiment, the instant invention provides halogenated latex polymer, a method of producing a halogenated latex polymer, a composition comprising a halogenated latex polymer and a method of making the composition, in accordance with any of the preceding embodiments, except that the halogenated latex polymer comprises polymer particles which are characterized by a particle size distribution such that at least 90 wt % of the polymer particles fall within ±30% of the volume average particle size. All values and subranges from at least 90 wt % are included herein and disclosed herein; for example, the percentage of polymer particles which fall within ±30% of the volume average particle size may be from a lower limit of 90, 92, 94, 96, 98 or 99 wt %.

In an alternative embodiment, the instant invention provides a composition and method of making a composition, in accordance with any of the preceding embodiments, except that the matrix polymer is selected from the group consisting of polycarbonates, polymethyl methacrylate, polystyrene, styrene-acrylonitrile copolymers, polystyrene methacrylate copolymers, styrene-methyl methacrylate copolymers, olefin-vinyl acetate copolymers, polymethylpentene, polyethylene, polypropylene, copolymers of polyethylene and polypropylene, polyglutarimide, styrene-maleic anhydride, copolymers, cyclic olefin copolymers, polyesters, polyethylene terephthalate and combinations thereof.

In an alternative embodiment, the instant invention provides a method of making halogenated latex polymer and method of making a composition, in accordance with any of the preceding embodiments, except that the contacting the copolymer with one or more halogen-containing compounds comprises contacting the copolymer with bromine water.

### EXAMPLES

The following examples illustrate the present invention but are not intended to limit the scope of the invention.

The following emulsion polymerization process was used to prepare the acrylic latex polymer used as Comparative Example 1 and further used to prepare Inventive Example 1.

### Emulsion Polymerization

1400 grams deionized water, 0.40 grams of acetic acid, 29 grams of sodium sulfate and 0.30 grams of iron sulfate heptahydrate were charged to a round bottom 5 liter glass reactor. The mixture in the glass reactor was stirred at 100 rpm and heated to 34° C. and sparged with nitrogen for 30 minutes; this is followed by the addition of 0.6 gms of sodium dithionite in 50 grams water. A monomer emulsion prepared by mixing: (1) 1400 grams butyl acrylate (BA), 348 grams of allyl methacrylate (ALMA), 74 grams of sodium lauryl sulfonate in 240 grams of water, vigorously mixed and then charged into the glass reactor in three equal portions. After each addition of the monomer emulsion, an exotherm was noticed and the reaction mixture was held at the peak exotherm temperature of for a period of 5 minutes and cooled to a temperature of 34° C.

Following the addition of three shots of the monomer emulsion, a stage 2 monomer emulsion, which was prepared by mixing 57 gms of deionized water with 24 gms of sodium lauryl sulfonate, and 200 gms of methyl methacrylate (MMA), was added to the reactor containing the latex described above. This was followed by addition of (1) 8 grams of a 2% solution of sodium persulfate solution and (2) 12 grams of a 2% solution of sodium formaldehyde sulfoxylate as shots, with each followed by a rinse of 2 grams of deionized water. The residual monomer was chased by addition of 30 grams of a 3% solution of hydrogen peroxide along with 128 grams of a 2% solution of sodium formaldehyde sulfoxylate, over a period of two hours. The particle sizes and solids were measured to be 190 nm and 52%, respectively.

The latex was then filtered. A portion of the filtered latex was set aside as Comparative Example 1. The remainder of the filtered latex was brominated according to the following procedure to prepare Inventive Example 1. The bromination is quantitative and can be controlled by using bromine water (Fisher Scientific, saturated bromine water, 3% w/v) as the reaction limiting reagent. Additionally, the bromination takes place very rapidly at room temperature.

### Bromination Procedure:

| | | |
|---|---|---|
| A. Core/shell latex described above (52% solids) | 1300 | gms |
| B. 10% sodium dodecyl benzene sulfonate | 100 | gms |
| C. Saturated Bromine water (Fisher Scientific) | 700 | gms |
| D. Dilute NaOH (1%) | 14 | gms |

1. Charged latex (A) into kettle;
2. Added soap (B) dropwise or in aliquots;
3. With stirring, slowly added bromine water dropwise into stirred (A), noted formation of gel, if any;
4. Adjusted pH to 7.2, with dropwise addition of NaOH;
5. Recorded starting pH and amount of dilute NaOH to reach a pH of 7.0;
6. Used rotovap to condense brominated emulsion to 20% solids; and
7. Freeze dried a the latex (60° C., 2 psi, 72 hours) for analysis including Raman spectra and thermogravimetry to determine residual unsaturation and the stability of the brominated copolymer respectively.

Immediately upon treatment with bromine water, the color of the latex was dark brown; within a few minutes the latex changed to white, indicating reaction of bromine with the residual double bonds.

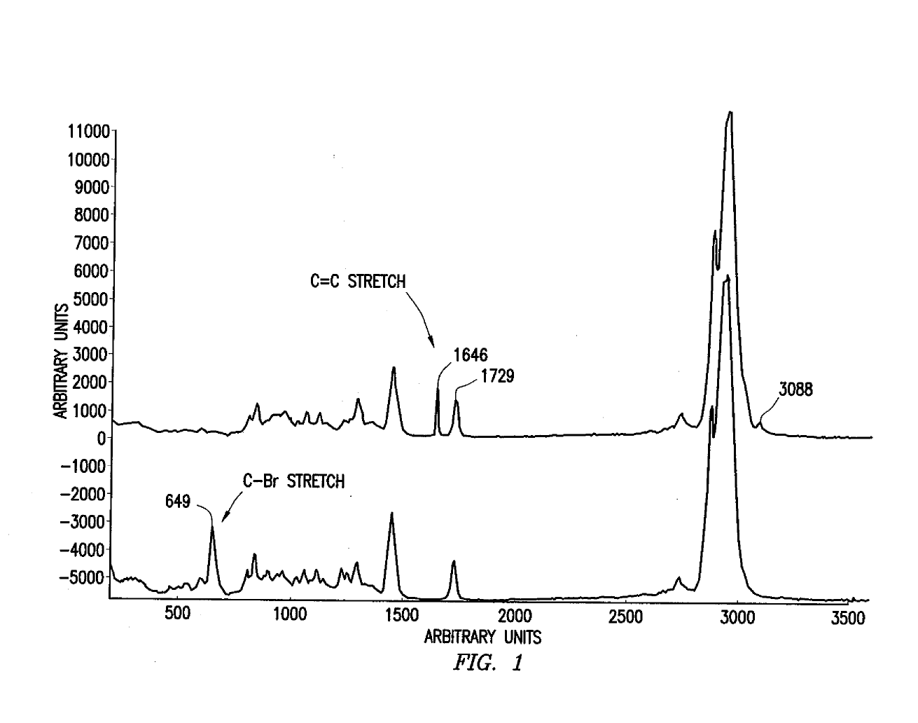

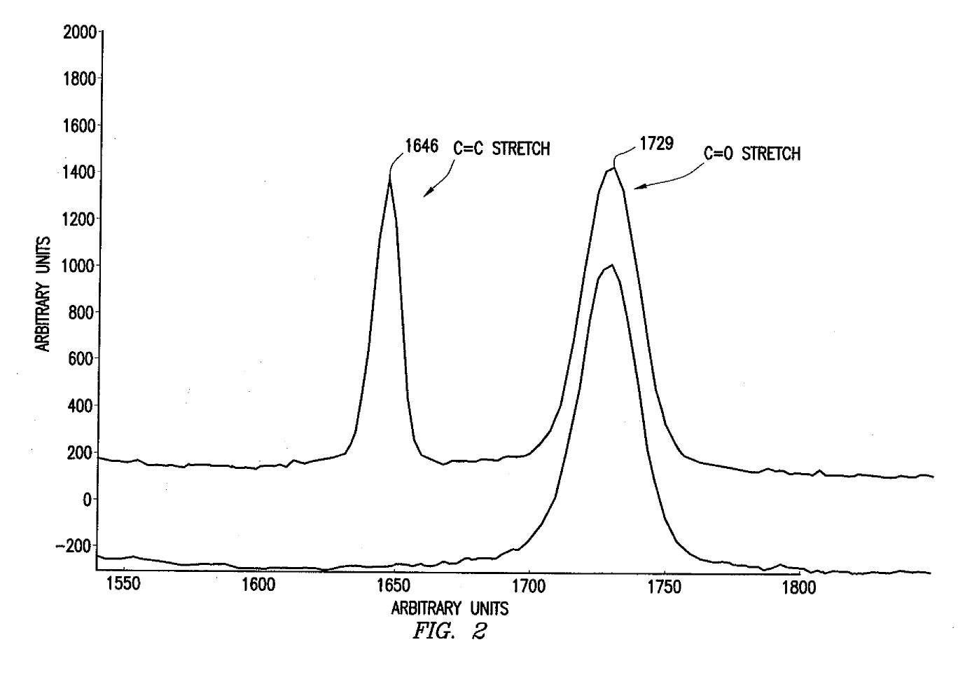

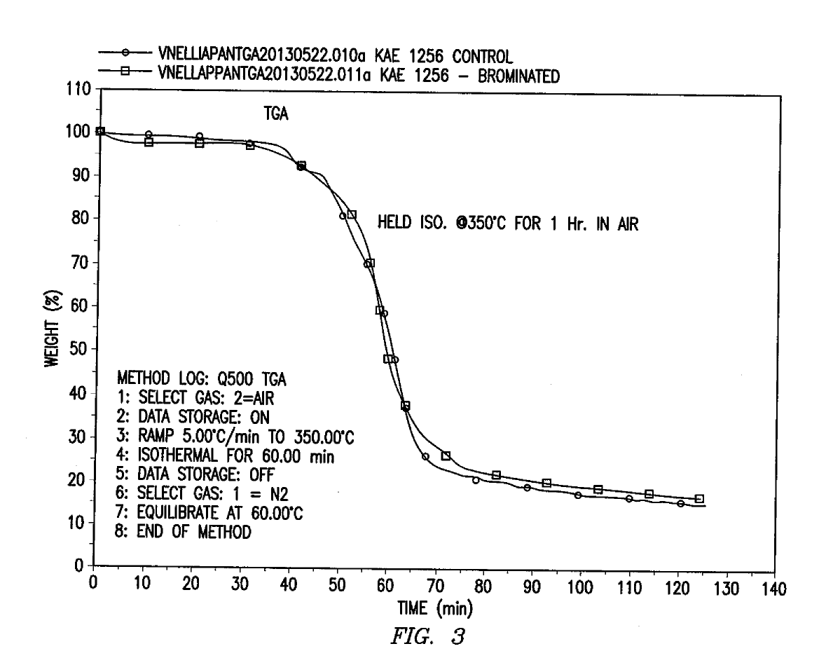

The Raman spectra in FIGS. 1 and 2 show that the C═C disappears in Inventive Example 1. The peak at 1646 cm⁻¹ is the C═C stretch and the peak at 3088 cm⁻¹ is the ═C—H stretch. The peak at 649 cm⁻¹ is consistent with a C—Br stretch. FIG. 3 shows the TGA of Comparative Example 1. The temperature at 5% weight loss is about 270° C. for Comparative Example 1. FIG. 4 shows the TGA of Inventive Example 1. The temperature at 5% weight loss is about 265° C. The bromine content of Inventive Example 1 above was measured to be 1.9% by XRF method.

Table 1 provides the XRF results for the Examples.

TABLE 1

| Sample ID | Br (wt %) |
|---|---|
| Comparative Example 1 | ND |
| Inventive Example 1 | 1.9 |
| std err | 0.1 |

ND = Not Detected.
Detection Limit ~0.002 wt %

### Test Methods

Test methods include the following:

X-Ray Fluorescence (XRF):

Inorganic elemental analysis was conducted using a Panalytical PW2404 Wavelength Dispersive X-Ray Fluorescence Spectrometer to determine the bromine concentration in these samples. XRF is a bulk elemental analysis technique which is capable of measuring elements from Na to U on the periodic table. Approximately 1.5 grams of sample were weighed into an XRF sample cup prepared with 6 micron polypropylene window. The samples were analyzed under helium with a Panalytical PW2404 X-Ray Fluorescence Spectrometer to determine the inorganic elemental composition. The results were quantitated with Uniquant software which has a detection limit of ˜0.002 wt % (20 ppm) for most elements. The analysis parameters are listed in Table 2 below.

TABLE 2
Instrument Operating Conditions & Data Analysis Parameters:

| | |
|---|---|
| Instrument: | Panalytical PW2404 X-Ray |
| | Fluorescence Spectrometer |
| Software: | Uniquant 5.48 |
| Archive(s): | Uniquant |
| Uniquant Job # (s): | 748 |
| Chemistry: | Elements |
| Shape #: | 10 |
| Case #: | 2 |
| Kappa List: | Any Sample |
| Helium: | Yes |
| Film/Window: | 1 |
| Diameter (mm): | 25 |
| Mass (mg): | ~1500 |
| % KnownConc: | #1 (H2O) (liquid samples only) |

The present invention may be embodied in other forms without departing from the spirit and the essential attributes thereof, and, accordingly, reference should be made to the appended claims, rather than to the foregoing specification, as indicating the scope of the invention.

1. A halogenated latex polymer, comprising from 0 to 90 percent by weight units derived from a first monomer and from 10 to 100 percent by weight units derived from a second monomer having at least one allylic group, wherein 10 to 100 percent of residual allyl groups of the second monomer are halogenated in a latex phase by dilute halogen water.

2. The halogenated latex polymer according to claim 1, wherein the second monomer is selected from the group consisting of allyl methacrylate, diallyl maleate, allyl acrylate, diallyl fumarate, diallyl itaconate, and combinations thereof.

3. The halogenated latex polymer according to claim 1, wherein the halogen water is bromine water.

4. The halogenated latex polymer according to claim 1, wherein the first monomer is butyl acrylate butyl acrylate, ethyl acrylate, 2-ethyl hexyl acrylate, propyl acrylate, methyl acrylate, hexyl acrylate, butyl methacrylate, methyl methacrylate, ethylhexyl methacrylate, benzyl acrylate, lauryl methacrylate and stearyl methacrylate, styrene or substituted styrenes, acrylonitrile.

5. The halogenated latex polymer according to claim 1, wherein the halogenated latex polymer comprises polymer particles which are characterized by light scattering to have an average diameter from 50 nm to 20 micrometers, a particle size distribution such that at least 90 wt % of the polymer particles fall within ±30% of the volume average particle size.

6. A composition comprising:
a blended product of:
a matrix polymer; and
from 0.05 to 10 wt % halogenated latex polymer, each said halogenated latex polymer comprising from 0 to 90 percent by weight units derived from a first monomer and from 10 to 100 percent by weight units derived from a second monomer having at least one allylic group, wherein from 10 to 100 percent of residual allyl groups of the second monomer are halogenated.

7. The composition according to claim 6, wherein the matrix polymer is selected from the group consisting of polycarbonates, polymethyl methacrylate, polystyrene, styrene-acrylonitrile copolymers, polystyrene methacrylate copolymers, styrene-methyl methacrylate copolymers, olefin-vinyl acetate copolymers, polymethylpentene, polyethylene, polypropylene, copolymers of polyethylene and polypropylene, polyglutarimide, styrene-maleic anhydride, copolymers, cyclic olefin copolymers, polyesters, polyethylene terephthalate and combinations thereof.

8. A method of producing halogenated latex polymer comprising:
copolymerizing a first monomer copolymerized with a second monomer, wherein the second monomer has at least one allyl group to form a copolymer using an emulsion polymerization process; and
contacting the copolymer with one or more halogen-containing compounds to produce a halogenated polymer.

9. The method of producing of producing halogenated latex polymer according to claim 8, wherein the contacting the copolymer with one or more halogen-containing compounds comprises contacting the copolymer with bromine water.

10. A method of forming a composition comprising:
blending halogenated latex polymer according to claim 1 into a matrix polymer.
